(19) United States
(12) Patent Application Publication
(10) Pub. No.: US 2007/0229887 A1
(43) Pub. Date: Oct. 4, 2007

(54) MANAGING SYSTEM, IMAGE PROCESSING APPARATUS, MANAGING APPARATUS, CONTROL METHOD THEREFOR, AND PROGRAM

(76) Inventor: Isamu Nakagawa, Kanagawa-ken (JP)

Correspondence Address: COWAN LIEBOWITZ & LATMAN P.C.;JOHN J TORRENTE, 1133 AVE OF THE AMERICAS, NEW YORK, NY, 10036, US

(21) Appl. No.: 11/692,408

(22) Filed: Mar. 28, 2007

(30) Foreign Application Priority Data
Mar. 31, 2006 (JP) 2006-100384

(51) Int. Cl. G06F 3/12

(52) U.S. Cl. 358/1.15

(57) ABSTRACT

This invention provides a managing system capable of achieving a low operational cost and high process efficiency of a system made up of a plurality of devices connected to each other via a network, an image processing apparatus, a managing apparatus, a control method therefore, and a program. To accomplish this, an information processing apparatus outputs, to an image processing apparatus, a job which uses a function provided by the image processing apparatus, and use limitation information of the function of the image processing apparatus that is used to process the job. The image processing apparatus receives the job and use limitation information. The image processing apparatus prints the job within the range of the use limitation information.

### BACKGROUND OF THE INVENTION

1. Field of the Invention

The present invention relates to a managing system which includes an image processing apparatus, an information processing apparatus that uses the function of the image processing apparatus, and a managing apparatus, and manages the use limitation of the image processing apparatus.

2. Description of the Related Art

A conventional method of controlling the use of a device is as follows.

1) The use limitation of device functions, the upper limit amount of use of each function, and the like are defined for each user.

2) An ACT (Access Control Token) which records the use amount per unit period, the upper limit amount, and permission/inhibition of the use of each function is generated when using a device.

3) Job data which designates a device operation is created.

4) The ACT is encrypted, and the job data is added to it and transmitted to the device.

5) The device decrypts the ACT, and checks whether the ACT is valid. If the ACT is valid, the device executes the job within the range of the ACT.

A method of grasping the use amount is as follows.

1) A device records the user name and the use amount of a job every time the job is complete. This data is called a job log.

2) A server computer obtains the job log from each device and saves it.

3) The server computer calculates the use amount for each user from the obtained job log.

For example, Japanese Patent Laid-Open No. 2003-67174 discloses an example of controlling the use of a device. According to this reference, the print count is totalized for each user during an arbitrary period using print log information stored in a printer. When the totalized print count exceeds a preset upper limit print count, a print request from the user is rejected.

There is proposed a technique of storing job information for each job. There is also proposed a technique of managing the job log of each department using a counter.

However, these conventional techniques increase the network traffic when the number of devices communicating with one server increases or the number of jobs executed by a device increases. The job log storable in a device has an upper limit, so the server computer must obtain the job log from the device before the job log in the device reaches the upper limit. Time required for obtaining the job log increases in proportion to the number of job logs, and the number of devices manageable by one server computer has an upper limit.

If job log information is managed as accumulated information by a counter immediately after receiving a job, job log information necessary for analysis by the administrator may be omitted. A large-scale printing system puts a heavy load on a hardware resource which uses a counter to manage accumulated values for all registered users including users free from any print limitation while holding job logs. It also puts a heavy load on the resource to hold and manage all pieces of transmitted job information.

### SUMMARY OF THE INVENTION

The present invention enables realization of a managing system capable of achieving a low operational cost and high process efficiency of a system made up of a plurality of devices connected to each other via a network, an image processing apparatus, a managing apparatus, a control method therefore, and a program.

According to one aspect of the present invention, a managing system includes an image processing apparatus, an information processing apparatus that uses a function of the image processing apparatus, and a managing apparatus, and manages use limitation of the image processing apparatus, the information processing apparatus comprising: an output unit adapted to output, to the image processing apparatus, a job which uses a function provided by the image processing apparatus, and use limitation information of the function of the image processing apparatus that is used to process the job, and the image processing apparatus comprising: a receiving unit adapted to receive the job and the use limitation information; a printing unit adapted to print the job within a range of the use limitation information; an obtaining unit adapted to obtain a use log of the function of the image processing apparatus for each job received by the receiving unit; a specifying unit adapted to specify a function of the image processing apparatus that is limited by use limitation information issued from the managing apparatus; a generating unit adapted to generate, from a use log obtained by the obtaining unit for each job, information representing an amount of accumulation use of each function of the image processing apparatus that is specified by the specifying unit; and a transmitting unit adapted to transmit the information which is generated by the generating unit and represents the amount of accumulation use, to the managing apparatus which manages the amount of accumulation use.

According to another aspect of the present invention, an image processing apparatus which processes a received job within a range of use limitation information, comprises an obtaining unit adapted to obtain a use log of a function of the image processing apparatus for each received job; a specifying unit adapted to specify a function of the image processing apparatus, use of which is limited by the use limitation information; a generating unit adapted to generate, from the use log obtained by the obtaining unit for each job, information representing an amount of accumulation use of each function of the image processing apparatus that is specified by the specifying unit; and a transmitting unit adapted to transmit the information which is generated by the generating unit and represents the amount of accumulation use, to a managing apparatus which manages the amount of accumulation use.

According to still another aspect of the present invention, a managing apparatus which issues use limitation information representing use limitation of an image processing apparatus, comprises an input unit adapted to input a use-limited function of the image processing apparatus that is determined for each printing issuing source; a requesting unit adapted to request, of the image processing apparatus, an amount of accumulation use of the use-limited function input by the input unit; and an issuing unit adapted to issue use limitation information by using the amount of accumulation use obtained by the request from the requesting unit and the use-limited function input by the input unit.

According to yet another aspect of the present invention, a method of controlling an image processing apparatus which processes a received job within a range of use limitation information, comprises the steps of: obtaining a use log of a function of the image processing apparatus for each received job; specifying a function of the image processing apparatus, use of which is limited by the use limitation information; generating, from the use log obtained in the obtaining step for each job, information representing an amount of accumulation use of each function of the image processing apparatus that is specified in the specifying step; and transmitting the information which is generated in the generating step and represents the amount of accumulation use, to a managing apparatus which manages the amount of accumulation use.

According to still yet another aspect of the present invention, a method of controlling a managing apparatus which issues use limitation information representing use limitation of an image processing apparatus, comprises the steps of: inputting a use-limited function of the image processing apparatus that is determined for each printing issuing source; requesting, of the image processing apparatus, an amount of accumulation use of the use-limited function input in the inputting step; and issuing use limitation information by using the amount of accumulation use obtained by the request in the requesting step and the use-limited function input in the inputting step.

According to yet still another aspect of the present invention, a computer-readable storage medium stores a computer program for causing a computer to execute a method of controlling an image processing apparatus which processes a received job within a range of use limitation information, the computer program comprising the steps of: obtaining a use log of a function of the image processing apparatus for each received job; specifying a function of the image processing apparatus, use of which is limited by the use limitation information; generating, from the use log obtained in the obtaining step for each job, information representing an amount of accumulation use of each function of the image processing apparatus that is specified in the specifying step; and transmitting the information which is generated in the generating step and represents the amount of accumulation use, to a managing apparatus which manages the amount of accumulation use.

Further features of the present invention will be apparent from the following description of exemplary embodiments with reference to the attached drawings.

### BRIEF DESCRIPTION OF THE DRAWINGS

FIG. 1 is a block diagram showing the configuration of a device managing system according to an embodiment of the present invention;

FIG. 2 is a block diagram showing the hardware configuration of a PC according to the embodiment of the present invention;

FIG. 3 is a block diagram showing the hardware configuration of a device according to the embodiment of the present invention;

FIG. 4 is a view showing an example of the basic structure of a memory map in the PC according to the embodiment of the present invention;

FIG. 5 is a view showing an example of the structure of an application and related data according to the embodiment of the present invention;

FIG. 6 is a view for explaining loading of an application and related data recorded on an ED into a computer according to the embodiment of the present invention;

FIG. 7 is a table showing an example of use limitation information according to the embodiment of the present invention;

FIG. 8 is a view showing an example of an editing window according to the embodiment of the present invention;

FIG. 9 is a view showing an example of a user information DB according to the embodiment of the present invention;

FIG. 10 is a view showing an example of a use results DB according to the embodiment of the present invention;

FIG. 11 is a flowchart showing a process executed by a printer driver according to the embodiment of the present invention;

FIG. 12 is a view showing job data according to the embodiment of the present invention;

FIG. 13 is a flowchart showing a process executed by an ACT issuing unit according to the embodiment of the present invention;

FIG. 14 is a view showing an example of the ACT according to the embodiment of the present invention;

FIG. 15 is a flowchart showing a process executed by a managing unit according to the embodiment of the present invention;

FIG. 16 is a view showing an example of results value update data according to the embodiment of the present invention;

FIG. 17 is a table showing an example of results management information held by the managing unit according to the embodiment of the present invention;

FIG. 18 is a view showing an example of a setup window according to the embodiment of the present invention;

FIG. 19 is a flowchart showing a process executed by a collecting unit according to the embodiment of the present invention; and

FIG. 20 is a view showing an example of the job log according to the embodiment of the present invention.

### DESCRIPTION OF THE EMBODIMENTS

Preferred embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

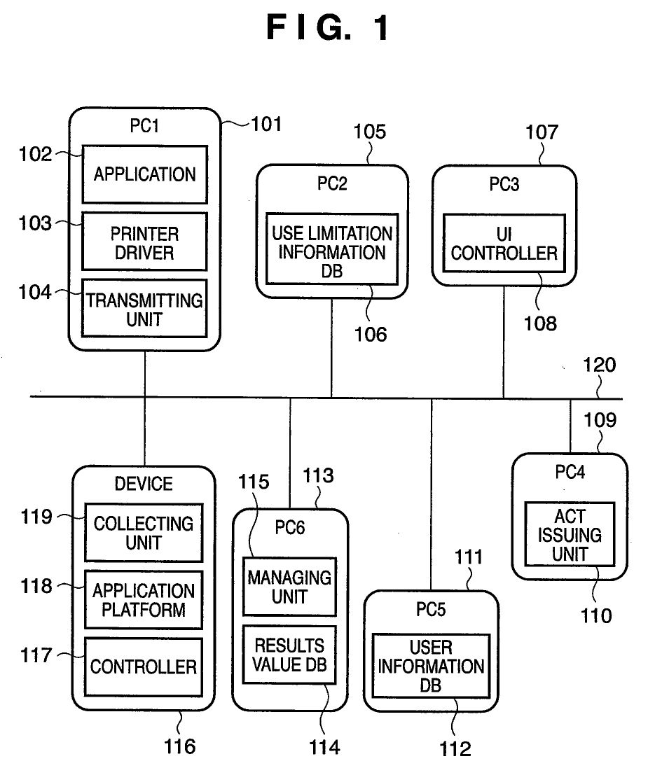

FIG. 1 is a block diagram showing the configuration of a device managing system according to an embodiment of the present invention.

The present invention is achieved by a system comprised a plurality of devices. The present invention is also achieved by supplying a program to a system or apparatus.

Reference numerals 101, 105, 107, 109, 111, and 113 denote PCs (Personal Computers). In each PC, an OS (Operating System) runs to manage various resources of the PC. FIG. 1 illustrates only characteristic functions of each PC. However, functions of each PC may be compositely implemented, or other functions may also be implemented.

Reference numeral 101 denotes PC 1. The user can create various document data via an application 102 running on the PC 101. If the user issues an instruction to print the document data, a printer driver 103 converts the data into, e.g., PDL (Page Description Language) data for printing by a device 116. A transmitting unit 104 transmits the PDL data to the device 116. Details of the process by the printer driver 103 will be described later.

Reference numeral 105 denotes PC 2. In the PC 105, a DBMS (Data Base Management System) runs and stores, e.g., a use limitation information DB (Data Base) 106. Use limitation information designates whether to permit/inhibit the use of a function provided by the device 116. The device 116 has a plurality of types of functions such as PDL printing, copying, FAX, and transmission, and the use limitation information can designate permission/inhibition of the use of each function. The use limitation information can also limit the printing amount of each function and limit the printing format. The use limitation information is manageable for each user or each group of one or more users.

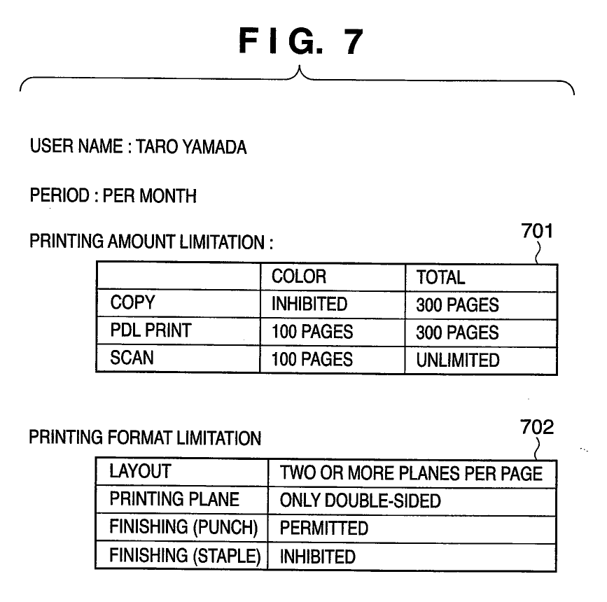

An example of the use limitation information will be explained with reference to FIG. 7.

FIG. 7 is a table showing an example of the use limitation information according to the embodiment of the present invention.

FIG. 7 shows use limitation information of user name “Taro Yamada” per month. A printing amount limitation table 701 quantitatively manages the use of each of functions (copy, PDL print, and scan) available in the device 116. “Color” represents a color output, and “total” represents the sum of color and monochrome outputs. In this example, as for the use of copying, user “Taro Yamada” cannot use color copying but can output a total of 300 pages.

As for PDL printing, user “Taro Yamada” can output up to 100 pages in color per month and can output a total of 300 pages. As for scanning, user “Taro Yamada” can scan up to 100 pages in color per month and can scan without any limitation in total. That is, after scanning 100 pages in color, user “Taro Yamada” can scan in only monochrome, but is free from any limitation on the number of pages.

A printing format limitation table 702 manages the limitation on the use format of each function available in the device 116. The layout is limited to two or more planes per page. In other words, the layout inhibits printing of assigning one logical page of a document to one page of an actual sheet. The layout permits only printing of assigning two or more logical pages to one page of an actual sheet.

The printing plane permits only double-sided printing, and inhibits single-sided printing. The finishing permits punching, and inhibits stapling.

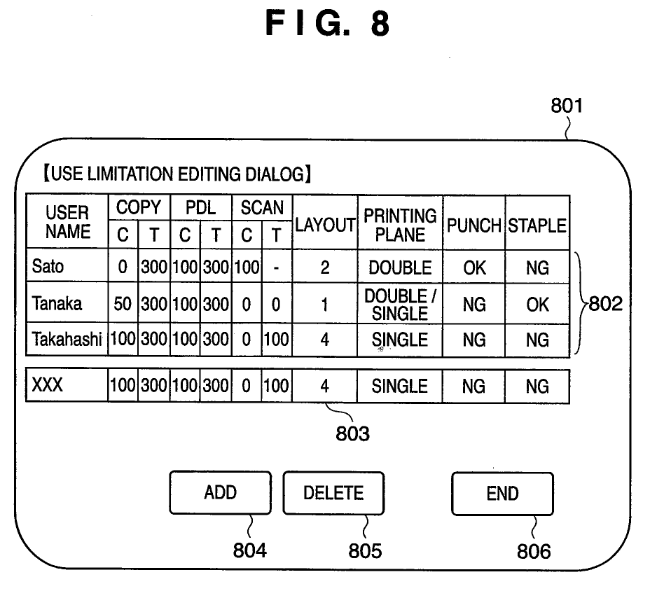

Referring back to FIG. 1, reference numeral 107 denotes PC 3. In the PC 107, a UI (User Interface) controller 108 runs. The UI controller 108 provides a function of editing information saved in the use limitation information DB 106. An example of an editing window provided by the UI controller 108 will be explained with reference to FIG. 8.

FIG. 8 is a view showing an example of the editing window according to the embodiment of the present invention.

FIG. 8 shows a user interface for editing use limitation information. Reference numeral 801 denotes a dialog window which provides an interactive interface with a user. Reference numeral 802 denotes a user list which obtains a user name set in the use limitation information DB 106 and corresponding use limitation information, and displays the contents. The user can select an arbitrary row of the user list 802 and execute various operations. This operation is implementable via, e.g., an input device (keyboard or mouse).

Reference numeral 803 denotes an editable text area used to designate data for adding a row to the user list 802. Reference numeral 804 denotes an add button. By operating the add button 804, the user can add the additional data in the editable text area 803 to a row designated in the user list 802.

Reference numeral 805 denotes a delete button. The user can operate the delete button 805 to delete a row designated in the user list 802. Reference numeral 806 denotes an end button. The user operates the end button 806 to save and update data on the user list 802 in the use limitation information DB 106, and close the dialog window 801. After that, changed data is transmitted to a managing unit 115 managed by the PC 113.

In the example of FIG. 8, numerical values in the copy, PDL, and scan columns each represent the number of planes outputtable or scannable during a unit period. Each column “C” represents the number of color planes, and “T” represents the total number of planes. The layout column represents the minimum number of logical pages laid out on one physical plane of a print sheet. The printing side column represents an allowable form. Only double-sided printing is possible for “double”, only single-sided printing is possible for “single”, and both of them are possible for “double/single”. “OK” and “NG” in the punching and stapling columns mean permission and inhibition, respectively.

Referring back to FIG. 1, reference numeral 109 denotes PC 4. In the PC 109, an ACT (Access Control Token) issuing unit runs. The ACT designates the above-mentioned use limitation information for each job. The ACT describes use limitation information associated with the use limitation/use results. Details of the process by an ACT issuing unit 110 will be described later.

Reference numeral 111 denotes PC 5. In the PC 111, a DBMS (Data Base Management System) runs and stores a user information DB (Data Base) 112. In an organization such as a company organization, users are often grouped and each group often has a hierarchical structure. For example, the hierarchical structure is comprised the president, departments, sections, and mere clerks (without any job title).

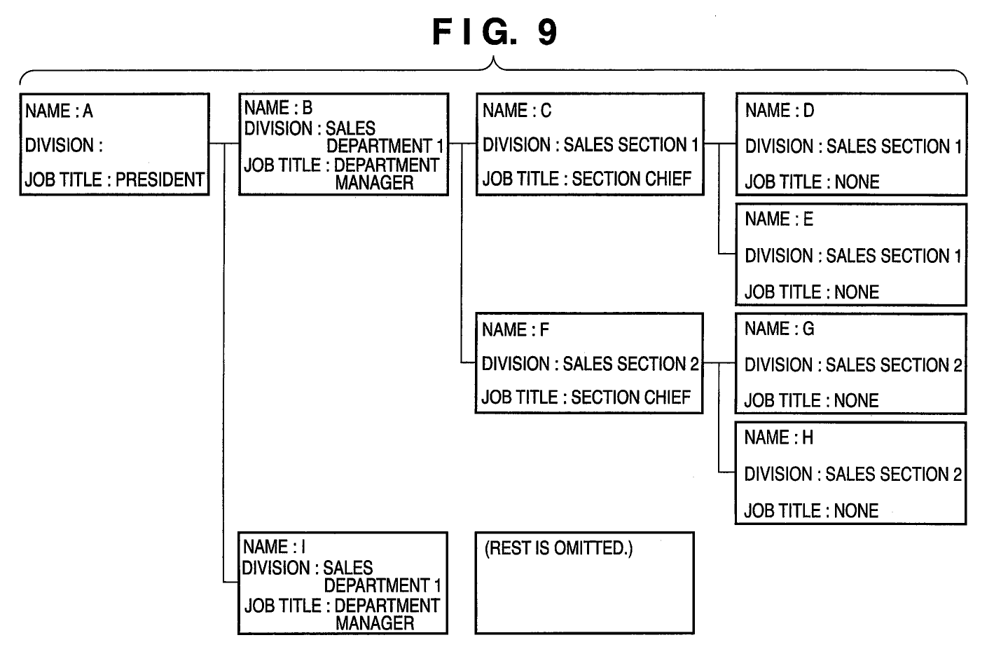

An example of the user information DB 112 will be explained with reference to FIG. 9.

FIG. 9 is a view showing an example of the user information DB according to the embodiment of the present invention.

Each user has name, division, and title attributes. The president manages a plurality of departments, and the department manager is the head of each department. The department manager manages a plurality of sections, and the section chief is the head of each section. Mere clerks without any job title belong to each section.

The embodiment manages the user information DB 112 independently of the use limitation information DB 106 in consideration of a case in which the access right of the system administrator to the user information DB 112 may be different from that to the use limitation information DB 106. If the system administrator has a right for read/write from/in the two DBs, these DBs are also manageable as one DB. The storage location of the user information DB 112 can also be a directory server instead of the DBMS.

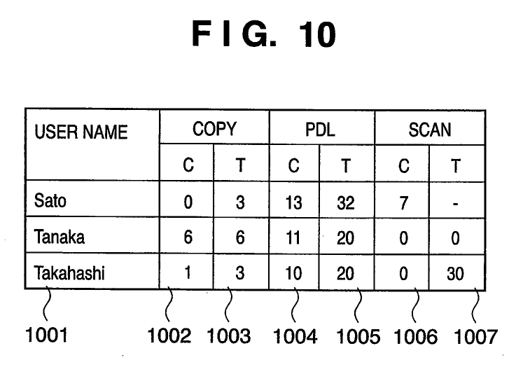

Reference numeral 113 denotes PC 6. In the PC 113, reference numeral 115 denotes a managing unit. The process by the managing unit 115 will be described later. In the PC 113, a DBMS (Data Base Management System) runs and stores a results value DB (Data Base) 114. An example of information stored in the results value DB 114 will be explained with reference to FIG. 10.

FIG. 10 is a view showing an example of the use results DB according to the embodiment of the present invention.

The use results value DB 114 takes a table form to store the number of output planes (amount of accumulation use (count)) corresponding to a user name serving as a key. Each row of the results value DB 114 represents information of one user. A column 1001 represents a user name. A column 1002 represents the current number of output planes of color copying by a corresponding user. A column 1003 represents the total number of output planes of copying. A column 1004 represents the number of output planes of color PDL printing. A column 1005 represents the total number of output planes of PDL printing. A column 1006 represents the total number of processed planes of color scanning. A column 1007 represents the total number of processed planes of scanning.

Referring back to FIG. 1, reference numeral 116 denotes a device which is a generally called multifunctional peripheral and has various functions such as printing of PDL data received via a network 120, copying, scanning, and transmission of scanned data. The device 116 is not limited to a multifunctional peripheral, and may be an output device such as a network printer or an input device such as a network scanner. In any case, the device 116 suffices to provide its functions with or without limitation to each user.

Reference numeral 117 denotes a controller which controls execution of various functions including printing. The controller 117 obtains an ACT contained in externally received job data, and processes the job data under use limitation based on the contents of the ACT. Reference numeral 118 denotes an application platform which provides a platform for operating an arbitrary application. Reference numeral 119 denotes a collecting unit which is an application running on the application platform 118 in the following description, but may be installed in the device 116. Details of the process by the collecting unit 119 will be described later.

The PCs 101, 105, 107, 109, 111, and 113 and the device 116 in FIG. 1 can communicate with each other via the network 120 to read/write necessary information. The communication protocol is, e.g., SOAP (Simple Object Access Protocol). SOAP is a protocol for calling data and services from another computer on the basis of XML (extensible Markup Language) and HTTP (Hyper Text Transfer Protocol).

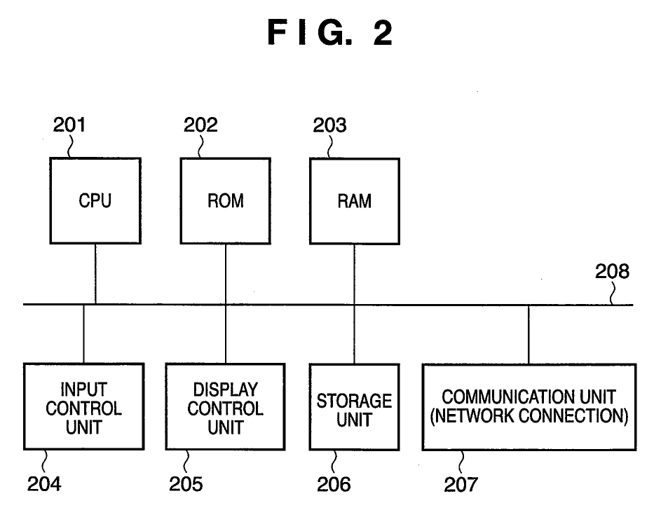

The hardware configuration of the PCs 101, 105, 107, 109, 111, and 113 will be described with reference to FIG. 2.

FIG. 2 is a block diagram showing the hardware configuration of the PC according to the embodiment of the present invention.

In FIG. 2, reference numeral 201 denotes a CPU (Central Processing Unit) which controls the overall computer apparatus and performs an arithmetic process and the like. Reference numeral 202 denotes a ROM (Read Only Memory) which is a storage area for various data such as a system startup program, applications, and parameters. Reference numeral 203 denotes a RAM (Random Access Memory) which is a data storage area free from any use limitation. The RAM 203 is an area where an operating system, application, device driver, communication control program, and the like are loaded and executed.

Reference numeral 204 denotes an input control unit which receives input data from a keyboard or pointing device (e.g., mouse) serving as an input device, and transfers the input data to the CPU 201. Reference numeral 205 denotes a display control unit which controls display on the display device. The display device is, e.g., a CRT or LCD.

Reference numeral 206 denotes a storage unit which is a so-called external storage device and is, e.g., a floppy® disk, hard disk, or SRAM (nonvolatile storage). The storage unit 206 stores programs and data, which are referred to or loaded into the ROM 202 in execution, as needed. Reference numeral 207 denotes a communication unit which controls network communication, and can communicate with other computers (e.g., PCs) and peripheral devices (e.g., device 116) connected to the network 120 in FIG. 1. Reference numeral 208 denotes a system bus which connects these components to each other and provides a data transmitting/receiving path.

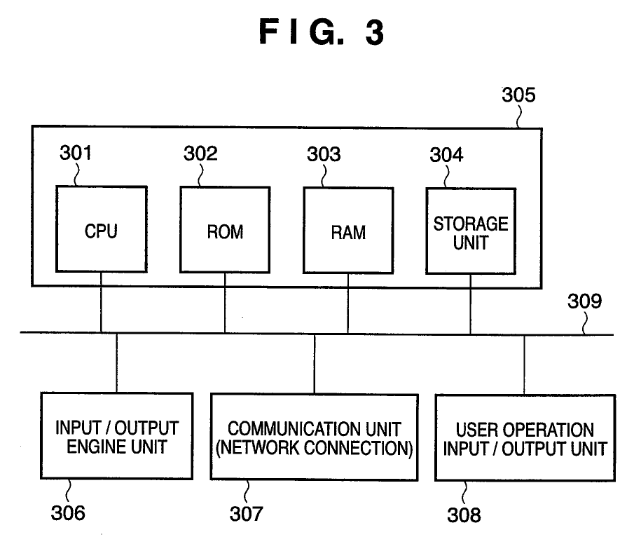

The hardware configuration of the device 116 will be described with reference to FIG. 3.

FIG. 3 is a block diagram showing the hardware configuration of the device according to the embodiment of the present invention.

In FIG. 3, reference numeral 305 denotes a controller which controls the whole device 116. In the internal arrangement of the controller 305, reference numeral 301 denotes a CPU (i.e., Central Processing Unit) which controls the controller 305 and performs an arithmetic process and the like. Reference numeral 302 denotes a ROM (Read Only Memory) which is a storage area for various data such as a system startup program, applications, and parameters. Reference numeral 303 denotes a RAM (Random Access Memory) which is a data storage area free from any use limitation. Reference numeral 304 denotes a storage unit which is a so-called external storage device and is, e.g., a hard disk or SRAM.

The RAM 303 is an area where an operating system and programs for communication control, engine control, and the like are loaded and executed. Reference numeral 306 denotes an input/output engine unit which executes a print operation and image reading operation under the control of the controller 305. More specifically, the input/output engine unit 306 comprises a printer engine which executes printing by a printing method such as laser beam printing, and a scanner engine having a sheet feed mechanism such as an ADF.

Reference numeral 307 denotes a communication unit which controls network communication, and can communicate with PCs functioning as client and server computers on the network 120 in FIG. 1. Reference numeral 308 denotes a user operation input/output unit which performs interactive setting work with the user. The user operation input/output unit 308 comprises, for example, a touch panel, input devices such as various keys and buttons, and a display device. Reference numeral 309 denotes a system bus which connects these components to each other and provides a data transmitting/receiving path.

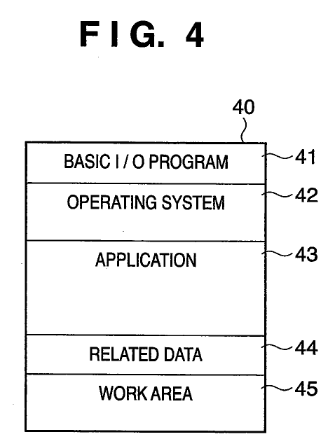

An example of the basic structure of a memory map in various PCs when executing the embodiment will be explained with reference to FIG. 4.

FIG. 4 is a view showing an example of the basic structure of the memory map in the PC according to the embodiment of the present invention.

Reference numeral 41 denotes a basic I/O program. Reference numeral 42 denotes an executable operating system such as the window system or the like. Reference numeral 43 denotes an application which is loaded into the RAM 203 and is executable. Reference numeral 44 denotes data related to the application which is loaded into the RAM 203 and is executable. Reference numeral 45 denotes a work area used by the application.

FIG. 4 merely shows the basic structure to implement a process executed by each PC shown in FIG. 1. Processes unique to each PC and programs to implement various processes such as database control are properly loaded into the RAM 203.

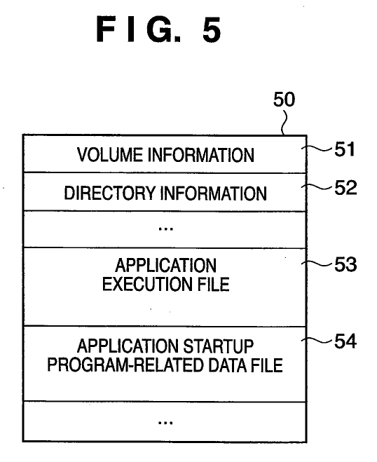

An application and related data to implement the embodiment are recorded on, e.g., a floppy® disk (FD). An example of the structure of the application and related data will be explained with reference to FIG. 5.

FIG. 5 is a view showing an example of the structure of the application and related data according to the embodiment of the present invention.

In FIG. 5, for example, volume information 51, directory information 52, an application execution file 53, and an application startup program-related data file 54 are recorded on a floppy® disk (FD) 50 recording area.

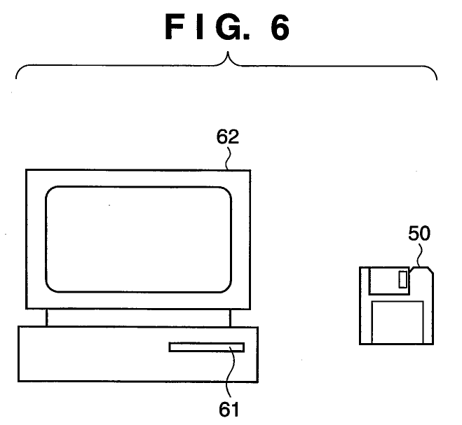

As shown in FIG. 6, the application and related data recorded on the floppy® disk (FD) 50 are loadable into the PC via an FD drive (DKC) 61 of a PC 62. When the user sets the floppy® disk (FD) 50 in the FD drive (DKC) 61, the application and related data are read out from the floppy® disk (FD) 50 under the control of the operating system 42 and basic I/O program 41. The application and related data are loaded into the RAM 203 and become available.

Another storage medium such as a CD-ROM or DVD-ROM is also available instead of the floppy® disk 50.

The storage unit 206 permanently stores the execution programs and data of various components implemented by the PC or device 116 in FIG. 1. If necessary, the execution programs and data are loaded into the RAM 203 and executed by the CPU 201.

In the PC, various components are the application 102, printer driver 103, transmitting unit 104, use limitation information DB 106, UI controller 108, ACT issuing unit 110, user information DB 112, use results value DB 114, and managing unit 115. In the device 116, various components are the controller 117, application platform 118, and collecting unit 119.

These components may be implemented not by programs, but by dedicated hardware or an arbitrary combination of software and hardware.

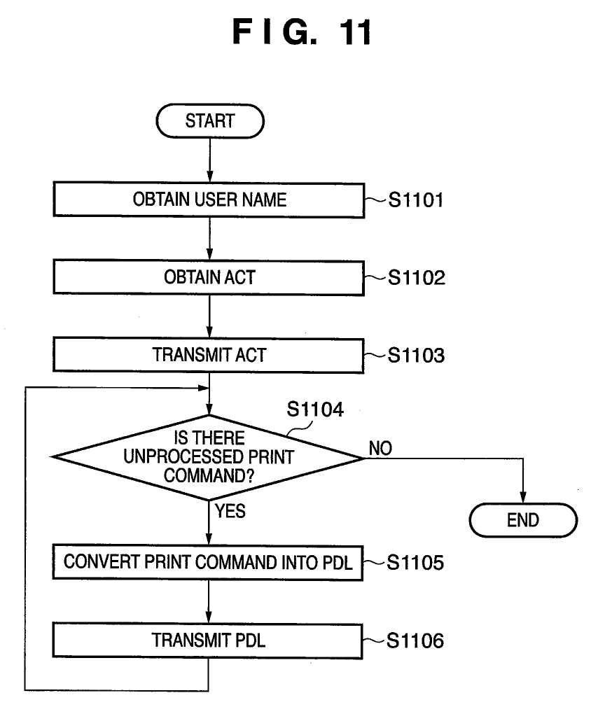

A process executed by the printer driver 103 will be explained with reference to FIG. 11.

FIG. 11 is a flowchart showing a process executed by the printer driver according to the embodiment of the present invention.

In step S1101, the printer driver obtains the user name of a user who is to print a job. The user name is stored in the API (Application Programming Interface) of a normal print instruction (print command) issued from the application 102.

In step S1102, the printer driver issues an ACT issuing request to the ACT issuing unit 110 (PC 109) using the user name as a key. The printer driver obtains a corresponding ACT from the ACT issuing unit 110 (PC 109).

In step S1103, the printer driver transmits the obtained ACT to the transmitting unit 104.

In step S1104, the printer driver determines whether there is an unprocessed print command among print commands from the application 102. If there is no unprocessed print command (NO in step S1104), the process ends. If there is an unprocessed print command (YES in step S1104), the process advances to step S1105.

In step S1105, the printer driver converts the print command from the application 102 into PDL data. Generally when printing from the application 102 running on the window system, the application 102 outputs a device-independent print command, and the printer driver 103 converts it into PDL data interpretable by a destination device.

In step S1106, the printer driver transmits the PDL data to the transmitting unit 104. The transmitting unit 104 adds the ACT, which has already been received in step S1103, to the received PDL data, and outputs the PDL data to a printing destination (e.g., device 116) designated by the print command.

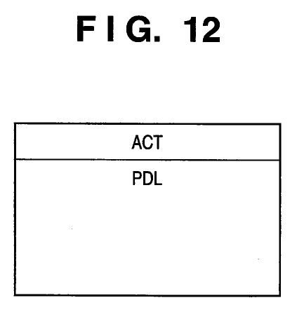

In this process, for example, an ACT is added to the header of data transmitted from the transmitting unit 104 to the device 116, and is accompanied by PDL data, as shown in FIG. 12.

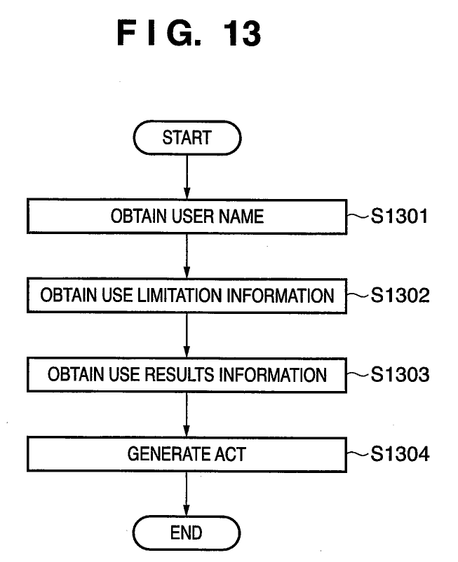

A process executed by the ACT issuing unit 110 will be explained with reference to FIG. 13.

FIG. 13 is a flowchart showing a process executed by the ACT issuing unit according to the embodiment of the present invention.

In step S1301, the ACT issuing unit 110 receives, e.g., an ACT issuing request from the PC 101, and obtains a user name contained in the ACT issuing request.

In step S1302, the ACT issuing unit 110 issues a use limitation information request using the obtained user name as a key, obtaining use limitation information of the user from the use limitation information DB 106 (PC 105).

In step S1303, the ACT issuing unit 110 issues a use results value request using the obtained user name as a key, obtaining the use results value of the user from the results value DB 114 (PC 113).

In step S1304, the ACT issuing unit 110 generates an ACT containing the obtained use limitation information and use results value. The ACT issuing unit 110 transmits the ACT to the ACT issuing source (e.g., PC 101).

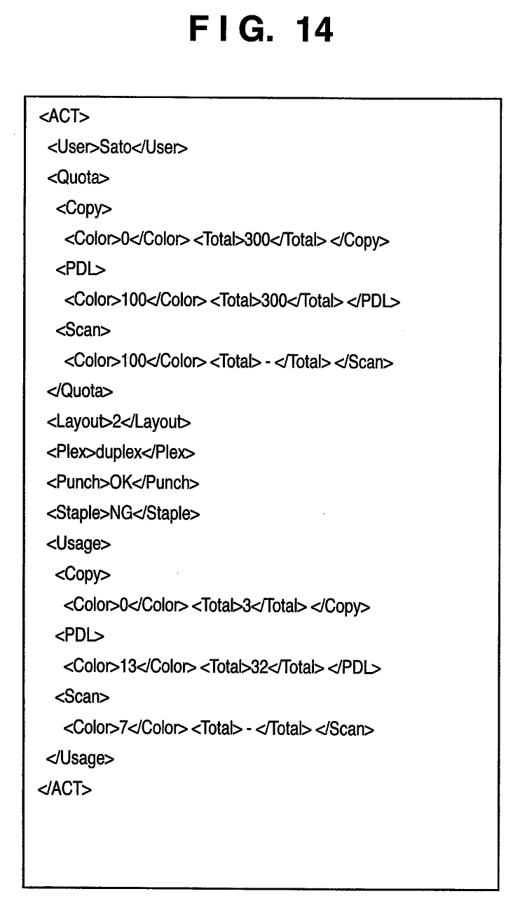

An example of the ACT will be described with reference to FIG. 14.

FIG. 14 is a view showing an example of the ACT according to the embodiment of the present invention.

The ACT containing the use limitation information and use results of user name “Sato” in FIG. 10 is expressed using, e.g., the XML language. The meanings of respective tags are as follows.

| Tag Name | Contents |
|---|---|
| ACT | ACT |
| Quota | upper limit |
| Copy | copy |
| PDL | PDL printing |
| Color | number of color output planes |
| Total | number of planes including color and |
| | monochrome planes |
| Layout | minimum number of logical planes assigned |
| | to one physical plane |
| Punch | permission/inhibition of punching function |
| Staple | permission/inhibition of stapling function |
| Usage | use results |

### The Quota tags (<Quota> to </Quota>) represent information obtained from the use limitation information DB 106. The Usage tags (<Usage> to </Usage>) represent information obtained from the results value DB 114.

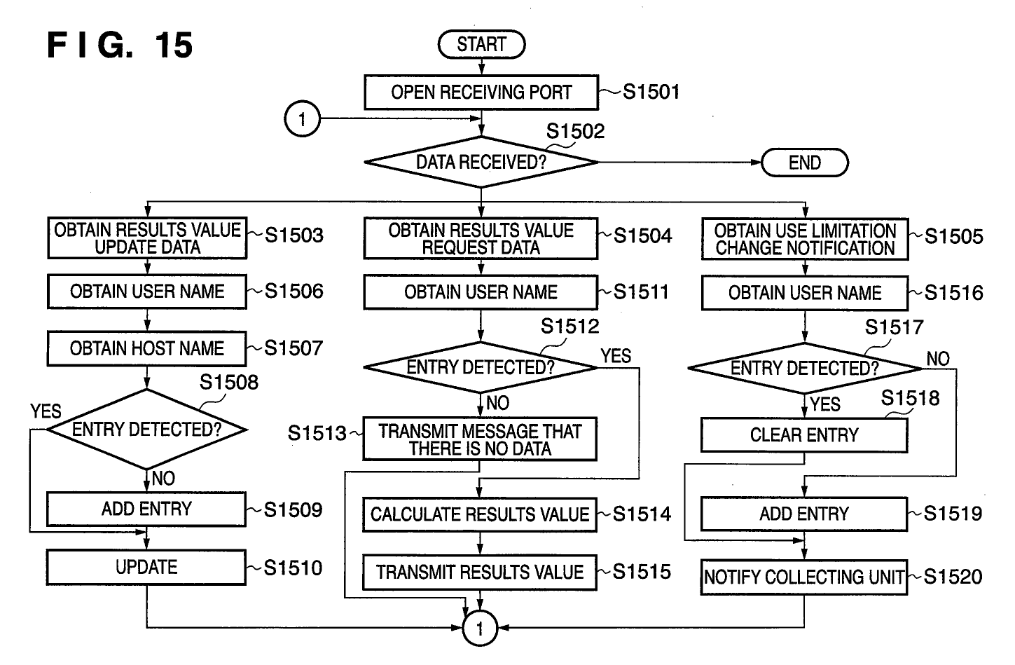

A process executed by the managing unit 115 will be described with reference to FIG. 15.

FIG. 15 is a flowchart showing a process executed by the managing unit according to the embodiment of the present invention.

In step S1501, the managing unit 115 opens a port for accepting a request from another component (e.g., PC 109). An example of the transport is TCP/IP.

In step S1502, the managing unit 115 determines whether it has received request data. If the request data is an end request, the process ends. If the request data is a results value update request (results value update data) from the collecting unit 119 (e.g., device 116), the process advances to step S1503. If the request data is a results value request (results value request data) from the ACT issuing unit 110 (e.g., PC 109), the process advances to step S1504. If the request data is a use limitation change notification from the UI controller 108 (e.g., PC 107), the process advances to step S1505. The use limitation change notification may be transmitted to the device in response to input of use limitation associated with the device function for each user to the use limitation information DB 106 which manages authentication information.

A process when receiving a results value update request from the collecting unit 119 will be explained. In this process, the managing unit 115 executes steps S1503 to S1510.

In step S1503, the managing unit 115 obtains results value update data from, e.g., the device 116.

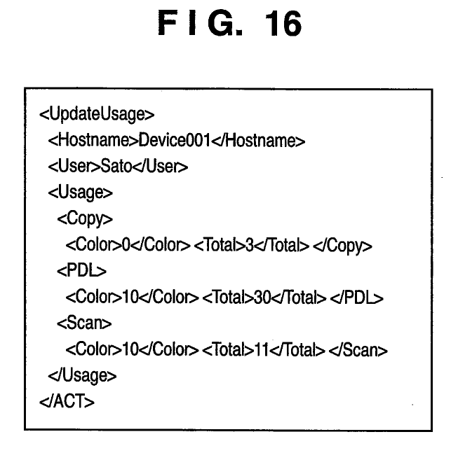

An example of the results value update data will be explained with reference to FIG. 16.

FIG. 16 is a view showing an example of the results value update data according to the embodiment of the present invention.

The results value update data is described in, e.g., the XML language. A description of the meanings of respective tags, which have already been explained with reference to FIG. 14, will be omitted. In FIG. 16, the tag <UpdateUsage> represents information on a results value update request, and the tag <Hostname> represents information on the host name of a requesting device.

Referring back to FIG. 15, in step S1506, the managing unit 115 obtains a user name from the obtained results value update data. In step S1507, the managing unit 115 obtains the host name of the requesting device from the obtained results value update data.

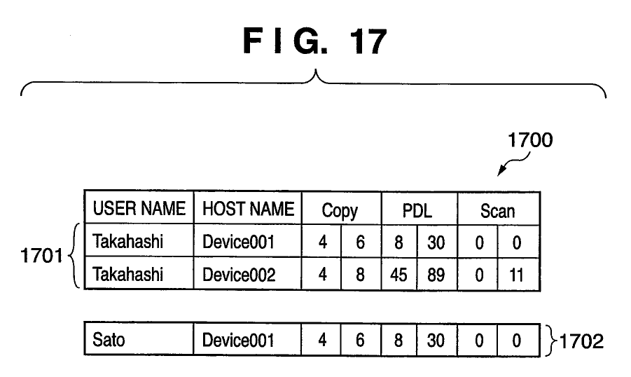

An example of results management information internally held by the managing unit 115 will be explained with reference to FIG. 17.

FIG. 17 is a table showing an example of results management information held by the managing unit according to the embodiment of the present invention.

Results management information 1700 is managed in the table using a user name and host name as keys. Each row represents the use results value of a device by a target user for each host name. Reference numeral 1701 denotes a use results value for user name “Takahashi”, and host name “Device0001” and “Device0002”.

In step S1508, the managing unit 115 refers to the results management information 1700 (FIG. 17) to search for an entry containing the user name obtained in step S1506 and the host name obtained in step S1507.

If the managing unit 115 detects the entry (YES in step S1508), the process advances to step S1510 to update the value of each item in the entry to the contents of the obtained results value update data.

If the managing unit 115 cannot detect the entry (NO in step S1508), the process advances to step S1509 to add, to the results management information 1700, an entry formed from the user name obtained in step S1506 and the host name obtained in step S1507. In step S1510, the managing unit 115 updates the value of each item in the entry to the contents of the obtained results value update data.

For example, when the results value update data shown in FIG. 16 is obtained in the state of FIG. 17, an entry 1702 and corresponding values are added.

A process when receiving a results value request from the ACT issuing unit 110 will be explained. In this process, the managing unit 115 executes steps S1504 to S1515.

In step S1504, the managing unit 115 obtains results value request data from, e.g., the PC 109. In step S1511, the managing unit 115 obtains a user name from the obtained results value request data.

In step S1512, the managing unit 115 refers to the results management information 1700 (FIG. 17) to search for an entry containing the user name obtained in step S1511. If the managing unit 115 cannot detect the entry (NO in step S1512), the process advances to step S1513 to transmit, to the results value request data-issuing source (PC 109), a message that there is no corresponding entry data.

If the managing unit 115 detects the entry (YES in step S1512), the process advances to step S1514 to calculate the sum of the values of items managed on a row of the user in the results management information 1700 (FIG. 17). The calculated sum is the use results values of all managed devices for the user. In step S1515, the managing unit 115 transmits the calculated results value to the results value request data-issuing source (PC 109). The managing unit 115 also updates the contents of the results value DB 114 using the calculated results value.

A process when receiving a use limitation change notification from the UI controller 108 will be explained. In this process, the managing unit 115 executes steps S1505 to S1520.

In step S1505, the managing unit 115 obtains a use limitation change notification from, e.g., the PC 107. In step S1516, the managing unit 115 obtains a user name from the obtained use limitation change notification. The managing unit 115 also holds the use limitation information shown in FIG. 7 for each user. This information will be called a management table.

In step S1517, the managing unit 115 searches the management table for an entry containing the user name obtained in step S1516. If the managing unit 115 detects the entry (YES in step S1517), it determines to delete the target entry. The process advances to step S1520 to delete the entry. If the managing unit 115 cannot detect the entry (NO in step S1517), it determines to newly add an entry. The process advances to step S1519 to add the entry to the management table.

Upon completion of updating the contents of the management table, the managing unit 115 notifies the collecting unit 119 (device 116) of the contents in step S1520. In response to this, the collecting unit 119 holds the management table as internal data. If necessary, the managing unit 115 may notify a use limitation change notification-issuing source (e.g., PC 107) of the completion of update.

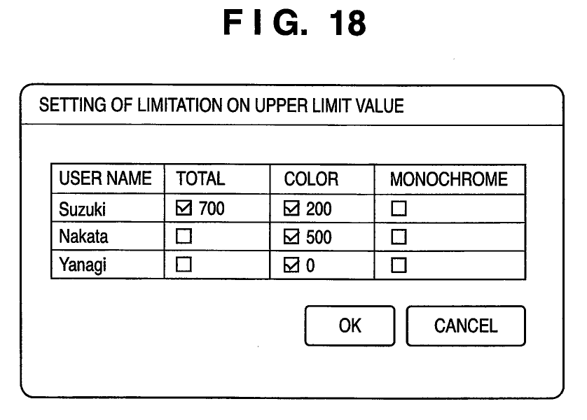

The managing unit 115 must periodically clear the use results value. This is because the use results value is generally set every month, every quarter, or every year. The period is set via a dedicated setup window (FIG. 18) in the UI controller 108. The managing unit 115 obtains the setting and periodically clears the use results value in FIG. 10.

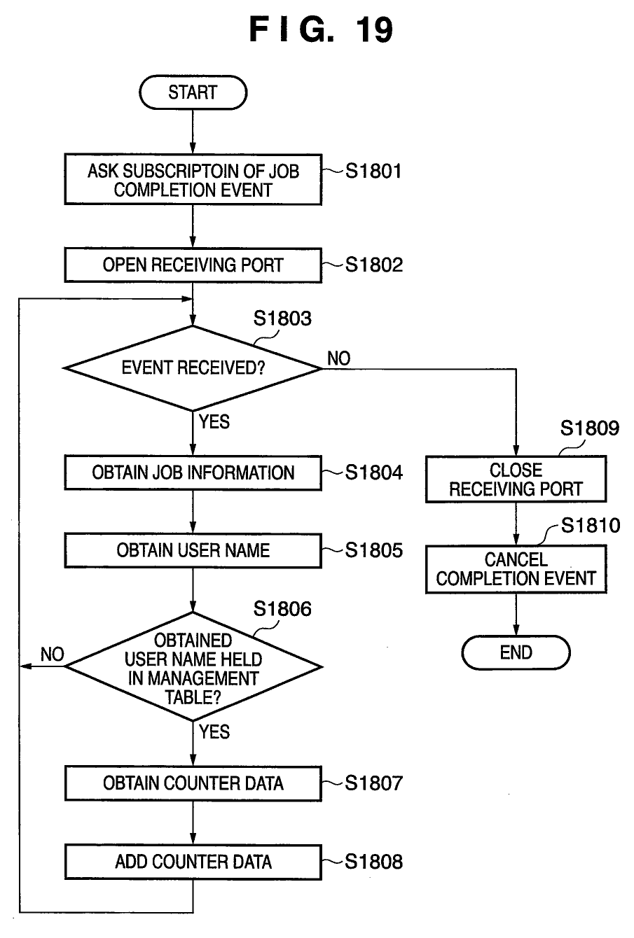

A process executed by the collecting unit 119 will be explained with reference to FIG. 19.

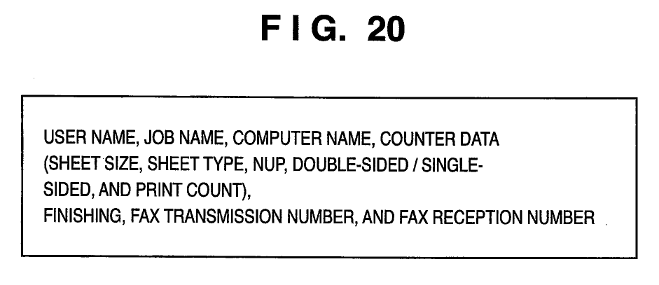

FIG. 19 is a flowchart showing a process executed by the collecting unit according to the embodiment of the present invention. FIG. 20 is a view showing an example of the job log. The job log contains the user name, job name, computer name, and counter data (sheet size, sheet type, NUP, double-sided/single-sided, and print count in each mode) of an issued job. The job log further contains the finishing, FAX transmission number, and FAX reception number.

The collecting unit 119 internally holds a management table and results value table for each user similar to the results value DB 114 (FIG. 10) and the management table notified from the managing unit 115 in step S1520 of FIG. 15.

In step S1801, the collecting unit 119 asks the controller 117 to subscribe for a job log addition event. Then, every time the job log is added, the controller 117 notifies the collecting unit 119 of the contents.

In step S1802, the collecting unit 119 opens an event receiving port. For example, the TCP/IP receiving port is opened. However, this process is done within a single device in this configuration, so the notification may be issued by an internal function call.

In step S1803, the collecting unit 119 determines whether it has received an event. If the event contents represent an end request, the process advances to step S1809. If the event contents represent a job log addition event, the process advances to step S1804.

In step S1804, the collecting unit 119 obtains job information (job log) requested to be added. The job log records information such as the execution user name, job name, and output counter data (e.g., one plane by color copying and three planes by monochrome PDL printing) of a job. FIG. 20 is a view showing an example of the job log.

In step S1805, the collecting unit 119 obtains a user name from the obtained job log.

In step S1806, the collecting unit 119 searches the management table notified in step S1520 for the obtained user name. If the collecting unit 119 cannot detect the obtained user name (NO in step S1806), the process returns to step S1803. If the collecting unit 119 detects the obtained user name (YES in step S1806), the process advances to step S1807.

In step S1807, the collecting unit 119 obtains a counter data value (count associated with print results output by a job corresponding to the obtained job log) from the obtained job log.

In step S1808, the collecting unit 119 adds the obtained counter data value to the value of each item in the entry of the user name in the results value table (accumulation update). Then, the process returns to step S1103. Assume that the management table shows that the user has sheet count limitations in the color and monochrome modes. In this case, when the counter value of the job log represents that five sheets are printed in color, the collecting unit 119 adds “5” to the counter data value of the color printing entry.

If no subsequent event occurs, the collecting unit 119 closes in step S1809 the event receiving port which has been opened in step S1102. In step S1810, the collecting unit 119 cancels the event asked in step S1801.

By the above process, the collecting unit 119 can accumulate, update, and hold only the results value of a user having use limitation. The collecting unit 119 periodically transmits the contents of the results value table as results value update data to the managing unit 115 (e.g., PC 113). Upon reception of the results value update data, the managing unit 115 executes processes in step S1503 and subsequent steps in FIG. 15 described above.

Considering a halfway change of use limitation information, the collecting unit 119 may have a function of recording the job log and calculate the results value from the recorded job log upon reception of a use limitation change notification.

A job log generated on the basis of issuing of a job may be erased in response to reflection of the job log as a results value. Alternatively, a processed job log may be accumulated without immediately easing it, and erased in accordance with an instruction from the administrator or upon the lapse of a specific time after the administrator uses the job log for an application purpose such as print analysis.

As described above, the embodiment can manage the results value of a user at a lower network traffic. This can increase the number of devices manageable by one computer, decrease the installation cost of hardware such as a PC, and decrease the operating cost for management.

The embodiment has exemplified a case in which a plurality of PCs and a device cooperate with each other to implement the embodiment. However, the present invention is not limited to this. For example, the present invention includes a case in which various components for implementing the embodiment are assembled into one PC, and the PC and a device implement the embodiment.

More specifically, the present invention is implementable by a system in which the PC 101 serves as a client to the device 116 and the PC 113 serves as a server (results management server) having the functions of the PCs 105, 107, 109, and 111. Alternatively, the present invention is also implementable by the device 116 and an information processing apparatus serving as an assembly of the client and server.

The embodiment has exemplified the use of the printing function of the device 116, but the present invention is not limited to this. That is, the present invention is applicable to each of functions (e.g., scanner function, FAX function, and data transmitting function) available in the device 116.

Each DB shown in FIG. 1 is stored in the PC, but may be stored in a network storage device connected to the network 120.

The embodiment has been described in detail above. The present invention can take an embodiment of a system, apparatus, method, program, storage medium, or the like. More specifically, the present invention may be applied to a system including a plurality of devices or an apparatus formed by a single device.

The present invention is also achieved by supplying a software program (in the above embodiment, programs corresponding to the flowcharts shown in the accompanying drawings) for implementing the functions of the above-described embodiment to a system or apparatus directly or from a remote place, and reading out and executing the supplied program codes by the computer of the system or apparatus.

The present invention is therefore implemented by program codes installed in the computer in order to implement functional processes of the present invention by the computer. That is, the present invention includes a computer program for implementing functional processes of the present invention.

In this case, the present invention may take the form of an object code, a program executed by an interpreter, script data supplied to an OS, or the like as long as a program function is attained.

A recording medium for supplying the program includes a floppy® disk, hard disk, and optical disk. The recording medium also includes a magnetooptical disk, MO, CD-ROM, CD-R, CD-RW, magnetic tape, nonvolatile memory card, ROM, and DVD (DVD-ROM and DVD-R).

As another program supply method, a client computer connects to an Internet homepage via the browser of the client computer. The computer program of the present invention or a compressed file containing an automatic installing function is downloaded from the destination homepage to a recording medium such as a hard disk, thereby supplying the program. The program can also be implemented by grouping program codes which form the program of the present invention into a plurality of files, and downloading the files from different homepages. That is, the present invention also incorporates a WWW server which allows a plurality of users to download the program files for implementing functional processes of the present invention by a computer.

The program of the present invention can be encrypted, stored in a storage medium such as a CD-ROM, and distributed to a user. A user who satisfies predetermined conditions is prompted to download decryption key information from a homepage via the Internet. The user executes the encrypted program using the key information, and installs the program in the computer.

The functions of the above-described embodiment are implemented when the computer executes the readout program codes. Also, the functions of the above-described embodiment are implemented when an OS or the like running on the computer performs some or all of actual processes on the basis of the instructions of the program codes.

Further, the program read out from the storage medium is written in the memory of a function expansion board inserted into the computer or the memory of a function expansion unit connected to the computer. The CPU of the function expansion board or function expansion unit performs some or all of actual processes on the basis of the instructions of the program codes, thereby implementing the functions of the above-described embodiment.

The present invention can provide a managing system capable of achieving a low operational cost and high process efficiency of a system made up of a plurality of devices connected to each other via a network, an image processing apparatus, a managing apparatus, a control method therefore, and a program.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-100384 filed Mar. 31, 2006, which is hereby incorporated by reference herein in its entirety.

What is claimed is:

1. A managing system which includes an image processing apparatus, an information processing apparatus that uses a function of the image processing apparatus, and a managing apparatus, and manages use limitation of the image processing apparatus,
the information processing apparatus comprising:
an output unit adapted to output, to the image processing apparatus, a job which uses a function provided by the image processing apparatus, and use limitation information of the function of the image processing apparatus that is used to process the job, and
the image processing apparatus comprising:
a receiving unit adapted to receive the job and the use limitation information;
a printing unit adapted to print the job within a range of the use limitation information;
an obtaining unit adapted to obtain a use log of the function of the image processing apparatus for each job received by said receiving unit;
a specifying unit adapted to specify a function of the image processing apparatus that is limited by use limitation information issued from the managing apparatus;
a generating unit adapted to generate, from a use log obtained by said obtaining unit for each job, information representing an amount of accumulation use of each function of the image processing apparatus that is specified by said specifying unit; and
a transmitting unit adapted to transmit the information which is generated by said generating unit and represents the amount of accumulation use, to the managing apparatus which manages the amount of accumulation use.

2. An image processing apparatus which processes a received job within a range of use limitation information, comprising:
an obtaining unit adapted to obtain a use log of a function of the image processing apparatus for each received job;
a specifying unit adapted to specify a function of the image processing apparatus, use of which is limited by the use limitation information;
a generating unit adapted to generate, from the use log obtained by said obtaining unit for each job, information representing an amount of accumulation use of each function of the image processing apparatus that is specified by said specifying unit; and
a transmitting unit adapted to transmit the information which is generated by said generating unit and represents the amount of accumulation use, to a managing apparatus which manages the amount of accumulation use.

3. The apparatus according to claim 2, wherein
said obtaining unit obtains, as the use log, a use log of each function available among functions of the image processing apparatus, and
said generating unit generates the amount of accumulation use from the use log obtained by said obtaining unit for each function available among the functions of the image processing apparatus.

4. The apparatus according to claim 2, wherein.
the use limitation information is managed for each user who uses the image processing apparatus, and
said generating unit generates information representing an amount of accumulation use by a user whose use of the image processing apparatus is limited by the use limitation information.

5. The apparatus according to claim 2, wherein said specifying unit receives information representing a function limited by the use limitation information from the managing apparatus, and specifies an amount of accumulation use of each function of the image processing apparatus that is to be generated by said generating unit.

6. A managing apparatus which issues use limitation information representing use limitation of an image processing apparatus, comprising:
an input unit adapted to input a use-limited function of the image processing apparatus that is determined for each printing issuing source;
a requesting unit adapted to request, of the image processing apparatus, an amount of accumulation use of the use-limited function input by said input unit; and
an issuing unit adapted to issue use limitation information by using the amount of accumulation use obtained by the request from said requesting unit and the use-limited function input by said input unit.

7. The apparatus according to claim 6, further comprising:
an accumulation use amount receiving unit adapted to receive the amount of accumulation use from the image processing apparatus;
a first storage unit adapted to store the use limitation information; and
an update unit adapted to update an amount of accumulation use stored in a second storage unit, on the basis of the amount of accumulation use received by said accumulation use amount receiving unit.

8. The apparatus according to claim 7, further comprising:
a use limitation information generating unit adapted to generate the use limitation information on the basis of storage contents stored in the first storage unit and the second storage unit; and
a use limitation information transmitting unit adapted to transmit the use limitation information to an information processing apparatus which uses a function of the image processing apparatus.

9. The apparatus according to claim 6, further comprising:
a setting unit adapted to set the use limitation information; and
a use limitation information transmitting unit adapted to transmit the use limitation information to a device when said setting unit updates the use limitation information.

10. The apparatus according to claim 7, wherein
said requesting unit transmits information representing the use-limited function to the image processing apparatus in response to input of use limitation on a function of the image processing apparatus for each user by said input unit to a database which manages authentication information, and
the accumulation use amount receiving unit receives an amount of accumulation use corresponding to the use-limited function from the image processing apparatus.

11. A method of controlling an image processing apparatus which processes a received job within a range of use limitation information, comprising the steps of:
obtaining a use log of a function of the image processing apparatus for each received job;
specifying a function of the image processing apparatus, use of which is limited by the use limitation information;
generating, from the use log obtained in the obtaining step for each job, information representing an amount of accumulation use of each function of the image processing apparatus that is specified in the specifying step; and
transmitting the information which is generated in the generating step and represents the amount of accumulation use, to a managing apparatus which manages the amount of accumulation use.

12. The method according to claim 11, wherein
in the obtaining step, a use log of each function available among functions of the image processing apparatus is obtained as the use log, and
in the generating step, the amount of accumulation use is generated from the use log obtained in the obtaining step for each function available among the functions of the image processing apparatus.

13. The method according to claim 11, wherein
the use limitation information is managed for each user who uses the image processing apparatus, and
in the generating step, information representing an amount of accumulation use by a user whose use of the image processing apparatus is limited by use limitation information is generated.

14. The method according to claim 11, wherein in the specifying step, information representing a function limited by the use limitation information is received from the managing apparatus to specify an amount of accumulation use of each function of the image processing apparatus that is to be generated in the generating step.

15. A method of controlling a managing apparatus which issues use limitation information representing use limitation of an image processing apparatus, comprising the steps of:
inputting a use-limited function of the image processing apparatus that is determined for each printing issuing source;
requesting, of the image processing apparatus, an amount of accumulation use of the use-limited function input in the inputting step; and
issuing use limitation information by using the amount of accumulation use obtained by the request in the requesting step and the use-limited function input in the inputting step.

16. The method according to claim 15, further comprising the steps of:
receiving the amount of accumulation use from the image processing apparatus;
storing the use limitation information in a first storage medium; and
updating an amount of accumulation use stored in a second storage medium, on the basis of the amount of accumulation use received in the accumulation use amount receiving step.

17. The method according to claim 16, further comprising the steps of:
generating the use limitation information on the basis of storage contents stored in the first storage medium and the second storage medium; and
transmitting the use limitation information to an information processing apparatus which uses a function of the image processing apparatus.

18. The method according to claim 15, further comprising the steps of:
setting the use limitation information; and
transmitting the use limitation information to a device when the use limitation information is updated in the setting step.

19. The method according to claim 16, wherein
in the requesting step, information representing the use-limited function is transmitted to the image processing apparatus in response to input of use limitation on a function of the image processing apparatus for each user in the inputting step to a database which manages authentication information, and
in the accumulation use amount receiving step, an amount of accumulation use corresponding to the use-limited function is received from the image processing apparatus.

20. A computer-readable storage medium storing a computer program for causing a computer to execute a method of controlling an image processing apparatus which processes a received job within a range of use limitation information, the computer program comprising the steps of:
obtaining a use log of a function of the image processing apparatus for each received job;
specifying a function of the image processing apparatus, use of which is limited by the use limitation information;
generating, from the use log obtained in the obtaining step for each job, information representing an amount of accumulation use of each function of the image processing apparatus that is specified in the specifying step; and
transmitting the information which is generated in the generating step and represents the amount of accumulation use, to a managing apparatus which manages the amount of accumulation use.
